(19) United States
(12) Patent Application Publication
(10) Pub. No.: US 2020/0005216 A1
(43) Pub. Date: Jan. 2, 2020

(54) USER NOTIFICATIONS BASED ON PROJECT CONTEXT

(71) Applicant: Microsoft Technology Licensing, LLC, Redmond, WA (US)

(72) Inventors: Jieqing Dai, Santa Clara, CA (US); Wenxiang Chen, Sunnyvale, CA (US); Declan Paul Boyd, San Francisco, CA (US); Ketan Thakkar, Santa Clara, CA (US); Qi Guo, Sunnyvale, CA (US); Patrick Cheung, San Francisco, CA (US); Jonathan Pohl, Redwood City, CA (US); Christine Liao, Oakland, CA (US)

(21) Appl. No.: 16/023,330

(22) Filed: Jun. 29, 2018

(51) Int. Cl. G06Q 10/06; G06Q 10/10; G06F 17/30; H04L 29/08

(52) U.S. Cl. CPC G06Q 10/063112; H04L 67/306; G06F 17/30528; G06Q 10/1053

(57) ABSTRACT

Disclosed herein are systems, methods, and non-transitory computer-readable media for providing user notifications based on a project context. The system may receive candidate attributes from candidate devices of a plurality of candidates and storing them in a candidate database, as well as user-entered attributes from a user device of a user. The system may then iteratively execute a number of operations that include performing a search for candidates in the candidate database by comparing project attributes with candidate attributes and providing user notification of newly-matched candidates that includes returning returned candidates that are matching candidates of the search results to the user based on the search. The system may generate context attributes from a context attribute source that include at least one of the user-entered attributes, candidate attributes of the returned candidates, candidate attributes of the selected candidate, candidate attributes of historical candidates, or project attributes of an additional project.

### TECHNICAL FIELD

An embodiment of the present subject matter a generally to notifications based on project context searching.

### BACKGROUND

Performing a database search based on a set of specified criteria may not yield the best results if the user is not entirely familiar with the full extent of the domains or criteria associated with the database. Thus, it may be possible to enhance the user's specified criteria with additional derived criteria. However, if the user is not properly notified when enhanced/derived criteria are applied to an automatically-run search returns new hits, opportunities may be lost for responding to new hits. Accordingly, improvements are needed.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings described below.

FIG. 1 is a block diagram of an example system for providing user notifications, according to some implementations.

FIG. 2 is a data structure diagram of an example project database, according to some implementations.

FIG. 3 is a flowchart showing an example method of providing notifications, according to some implementations.

FIG. 4 is a block diagram illustrating an example software architecture, which may be used in conjunction with various hardware architectures herein described.

FIG. 5 is a block diagram illustrating components of a machine, according to some example embodiments, able to read instructions from a machine-readable medium (e.g., a machine-readable storage medium) and perform any one or more of the methodologies discussed herein.

FIG. 6 is a block diagram illustrating an example network architecture that may be utilized, according to some implementations.

### DETAILED DESCRIPTION

In the following description, for purposes of explanation, various details are set forth in order to provide a thorough understanding of some example embodiments. It will be apparent, however, to one skilled in the art, that the present subject matter may be practiced without these specific details, or with slight alterations.

Reference in the specification to “one embodiment” or “an embodiment” means that a particular feature, structure, or characteristic described in connection with the embodiment is included in at least one embodiment of the present subject matter. Thus, the appearances of the phrase “in one embodiment” or “in an embodiment” appearing in various places throughout the specification are not necessarily all referring to the same embodiment. The same is true when the word “implementation” and “example”.

For purposes of explanation, specific configurations and details are set forth in order to provide a thorough understanding of the present subject matter. However, it will be apparent to one of ordinary skill in the art that embodiments of the subject matter described may be practiced without the specific details presented herein, or in various combinations, as described herein. Furthermore, well-known features may be omitted or simplified in order not to obscure the described embodiments. Various examples may be given throughout this description. These are merely descriptions of specific embodiments. The scope or meaning of the claims is not limited to the examples given.

Disclosed herein are systems, methods, and non-transitory computer-readable media for providing user notifications based on a project context. In the system, a process may be utilized for, using a processor of the system, receiving, via a network interface, candidate attributes from candidate devices of a plurality of candidates and storing them in a candidate database in a memory of the computer system. The system may receive, via the network interface, user-entered attributes from a user device of a user that are a first part of project attributes of a project and store the project attributes in a project database in the memory.

The system may then iteratively execute a number of operations. These operations may include performing a search for candidates in the candidate database by comparing project attributes with candidate attributes and providing user notification of newly-matched candidates that includes returning returned candidates that are matching candidates of the search results to the user based on the search, the returned candidates being candidates that the user has not previously seen, and marking the returned candidates as previously seen. A selected candidate may be received of the returned candidates selected by the user. The system may then generate context attributes that are a second part of the project attributes from a context attribute source, wherein the generated context attributes include at least one of the user-entered attributes, candidate attributes of the returned candidates, candidate attributes of the selected candidate, candidate attributes of historical candidates, or project attributes of an additional project. Such a system may be utilized in, for example, a job recruitment service that allows recruiters to match candidates with jobs. The generation of the context attributes and their subsequent use in order to assist the user to conduct a better database search constitutes a technical improvement in the technical field of database searching, yielding better search results for the user than would otherwise be possible.

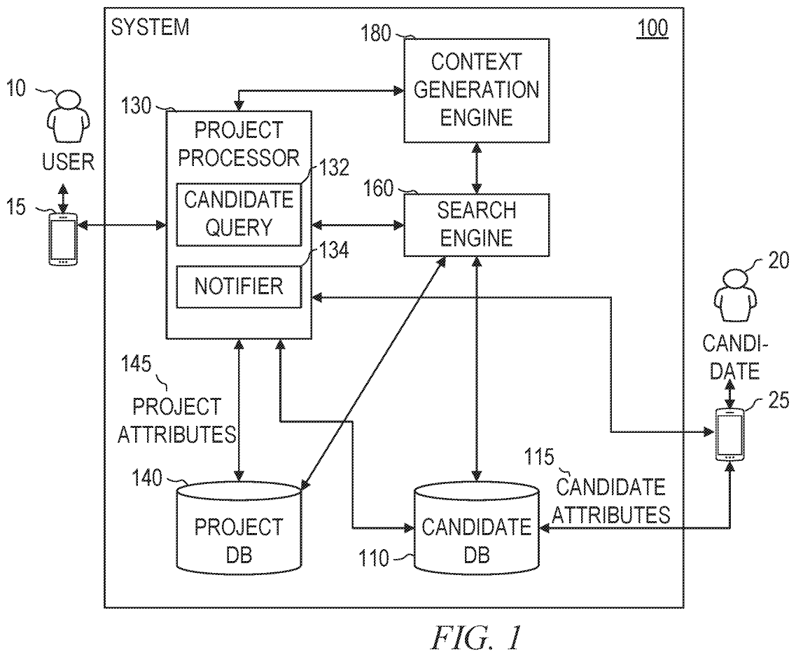

FIG. 1 is a block diagram that shows a system 100, for a context-based search. In the example described below, the context-based search involves a recruiter searching for suitable job candidates from a candidate pool, and providing notice of new candidates based on evolving criteria. However, the system 100 is not limited to this example, and it may encompass any form of a search based upon a set of attributes or characteristics of elements in a target database.

As shown in 1, a user 10 may interact with the system 100 via a user device 15. Such a user device 15 may be any device as described below that permits a user to access and interact with the system 100. A candidate 20 may also interact with the system 100 with their own candidate device 25 that similarly may be any device as described below that permits the candidate to access and interact with the system 100. The user device 15 and the candidate device 25 may be, by way of example, a machine 500 or an end user element 610 as described in more detail below. The system 100 may be, by way of example, a system such as a data center 620 described in more detail below.

In this example, the candidate 20 may enter their attributes as target elements for the target database, which in the example is a candidate database 110. The candidate attributes 115 may include attributes such as skills, identification, biometric information, a job title of interest, previous jobs held, salary information, location information, demographic information, such as age, gender, etc. It may include any information that might he found on a resume, including key descriptive words, prior employers, education, interests. The candidate attributes 115 may serve as the target criteria for a search conducted by the user 10 who is seeking one or more candidates 20 for a particular project.

A user 10, who may be a recruiter seeking one or more candidates 20, may create a project that is stored in a project database 140. The project may contain project attributes 145 that describe the candidate attributes 115 of interest for a particular job or position. A project processor 130 may interface with the user device 15 and allow the user 10 to create or modify the project attributes 145. The project attributes may include attributes such as those of the candidate attributes identified above, although there need not be a one-to-one correspondence.

Once the project attributes 145 have been created, the user may execute a candidate query 132 in order to find one or more suitable candidates 20. The candidate query 132 may utilize a search engine 160 that determines some measure of fit between the project attributes 145 and candidate attributes 115 of the candidates in the candidate database 110. The attribute matching does not need to be all or nothing. For example, if a project attribute is that the candidate have at least five years of experience, a candidate in the database having four years of experience might be an 80% match, and a candidate in the database having three years of experience might be a 30% match. Thus, the matching algorithm may assign varying degrees of matching between the attributes.

An overall matching score for a particular candidate may be determined based on some weighted attribute or weighted factor analysis. For example, the candidate's location combined with a willingness to relocate may be much more important than the candidate's experience with a particular programming language. The weightings may be provided by the user 10, or may be empirically determined, based on some evaluation of an end result, which may be the selection by the user of a particular candidate.

After the user 10 has initiated the candidate query 132 and the search engine 160 has located matching candidates whose candidate attributes 115 match the project attributes 145 according to some matching criteria, and overall matching score may be assigned to the candidate, and a set of matching candidates may be assembled from candidates whose overall score exceeds some threshold, or assembled based on some predefined number of best scoring candidates. Thus, the search may determine candidate match scores for candidates in the candidate database that utilizes an attribute weighting and degree of match between one or more project attributes and corresponding candidate attributes, and the returned candidates from the search are those candidates whose candidate match score exceed a pre-determined threshold.

The set of matching candidates may be presented to the user 10 on the user's device 15 by way of a notifier 134 that sends a user notification to the user 10 of new unseen (e.g., newly matched) candidates 20 for a given project (although, as described below, this “unseen” parameter may be configurable). The first time this operation is run for a given project, all search results meeting the predetermined criteria will be displayed, since none of the resultant candidates have been seen by the user 10 at this time.

The operation of the notifier 134 may be triggered by a notification trigger that may be, e.g., a completion of the candidate query or search 132 and creating of the set of matching candidates. The user notification and/or the presentation may be displayed within a web browser user interface or in a user interface of a dedicated application, e.g., within a displayed field or a pop-up window—they may also be presented to the user 10 in an email, text message, or in some other type of file. The mechanism for presenting the set of matching candidates is not critical, other than it should allow the user 10 to indicate, via a selection mechanism, some subset of the set of matching candidates that are of interest in further pursuing. For example, the mechanism for presenting the set of matching candidates may be presenting the candidates in a list on a display screen, with the selection mechanism being that each candidate has a checkbox adjacent to it permitting the user 10 to place a checkmark in the checkbox for those candidates of interest.

Information about the candidates of interest may then be sent back to the project processor 130. The project processor 130 may then take further action with regard to the candidates of interest. For example, the project processor 130 may send a candidate notification to each of the candidates 20 of interest, letting them know of the user's 10 interest in further interaction with them. For example, the interest in further interaction may be a request to set up an interview or a plant visit. The contacting of these candidates 20 of interest may be in the form of an email, a text message, and in application message, or any other mechanism for notification, such as those used for the user notification described above. The project processor 130 may track input from the candidates' 20 response to receiving notification of the users interest, which may subsequently be used, as described below, in modifying the project context.

It may be, however, that the user 10 is not sophisticated in providing the best project attributes 145 for the project. For example, the user 10 may indicate, as one of the project attributes 145, a project title of “software engineer”, and another of the project attributes 145 as requiring eight or more years of experience in the field. The user 10 may not realize that a project title of “senior software engineer” may be a more appropriate attribute for the project, or at least an attribute that is more likely to match with that of the desired candidate 20. This may be a problem that results in not all of the best candidates 20 being retrieved in the search.

In order to assist the user 10 in finding the best candidate 20 for the project, a context generation engine 180 may be utilized to determine other project attributes 145 that may be helpful in locating the most desirable candidates 20, based on various factors, In the example given above, the context generation engine 180 may deduce that most software engineers with eight years of experience will be classified as a “senior software engineer”, and thus add this job title attribute into the project attributes 145 that may be utilized in a subsequent search.

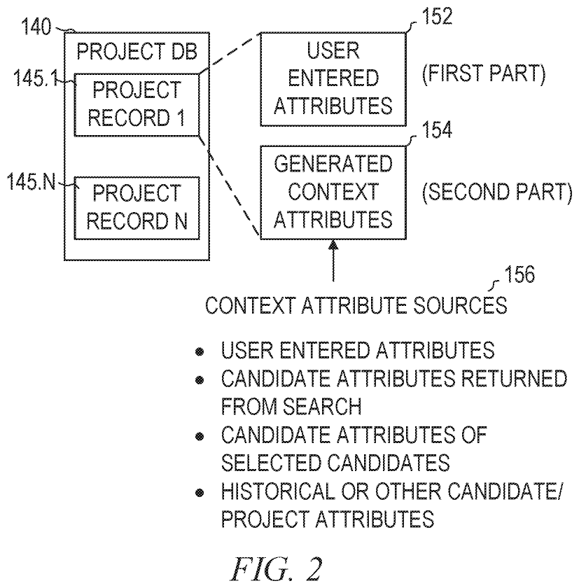

FIG. 2 is a block diagram that illustrates the project database 140 having a number of projects contained therein, illustrated by a first project attribute record 145.1 through an nth project attribute record 145.N (collectively or as an example of such record referred to with the reference numeral 145). Each project attribute record 145 may be comprised of user-entered attributes 152, and generated context attributes 154. The context attributes 154 may be determined based on the user entered attributes 152, as in the example described above. The context attributes 154 may be those that are determined in other ways besides direct user entry of the attributes and are not present in the user-entered attributes 152.

The context attributes 154 may also be determined based on the candidate attributes returned from the search. For example, with the software engineer and eight or more years of experience attributes provided as user entered attributes 152 for the project attributes 145, the candidates returned from the candidate query 132 may frequently have “senior software engineer” as a candidate attribute 115 associated with them. Based on this frequency of the candidate attribute 115 in the results returned from the search, the context generation engine 180 may determine that this is an attribute that should be added to the project attribute record 145.

Furthermore, the context attributes 154 may also be determined based on the user's 10 selection of candidates 20 within the set of candidates returned from the search. For example, performing the initial user search having only project attributes of software engineer and eight or more years of experience, the search may return some candidates 20 having an attribute of software engineer, and other candidates 20 having an attribute of senior software engineer. If the user 10 selects mostly the candidates having the attribute of senior software engineer and does not select many candidates having the attribute of software engineer, then the context generation engine 180 may determine that senior software engineer is a better project attribute 145, than software engineer, and eliminate or deemphasize the software engineer attribute while adding or emphasizing, through weighting, the senior software engineer attribute.

Although the above discusses these context attributes sources 156 that may be utilized by the context generation engine 180, the system 100 is not so limited, and any measurable factors or attributes may be included in the equation. For example, attributes of those candidates 20 who interviewed successfully, and were extended an offer may impact the inclusion of or weighting of candidate attributes 115 that are included in the generated context attributes 154 of the project attributes 145 provided the events are detectable or accessible by the system 100. Similarly, attributes of those candidates 20 who accepted the offer may impact the inclusion of attributes and weightings as well. In another example, even the employee performance characteristics post-hire may be included as well. For example, if an employee has been with the company for three years and received excellent performance reviews, their candidate attributes 115 may be considered to be good predictors of good employee performance, and thus be used to modify generated context attributes 154 for other similar project attributes.

For the system 100, the search engine is no longer run once the candidate 20 has accepted a position identified by the project. However, that does not mean that subsequent data related to job performance is no longer valuable with respect to similar projects, and thus historical candidate/project attributes 115, 145 may also serve as context attributes sources 156.

The candidate query 132 may be run initially by the user 10 once the user entered attributes 152 for the project are entered. This initial candidate query 132 may be initiated by the user 10 expressly initiating it, and in one example, this initial candidate query 132 only utilizes the user entered attributes 152. However, in another example, certain generated context attributes 154 that may be quickly and easily determined, such as the software engineer, senior software engineer attribute discussed above, may be included in the initial candidate query 132.

In one implementation, the system 100 may separately display the user-entered attributes 152 and the generated context attributes 154 so that the user 10 can see which attributes are being used to search for candidates that he/she did not expressly specify. It may further show the basis (i.e., the matching attributes and weightings) for which a particular candidate was matched.

In one implementation, the system 100 may gradually learn over time what the best project attributes 145 are to be used and their weightings based on feedback received from the attributes of selected candidates, those candidates who respond to being notified, or other of the context generation elements discussed above.

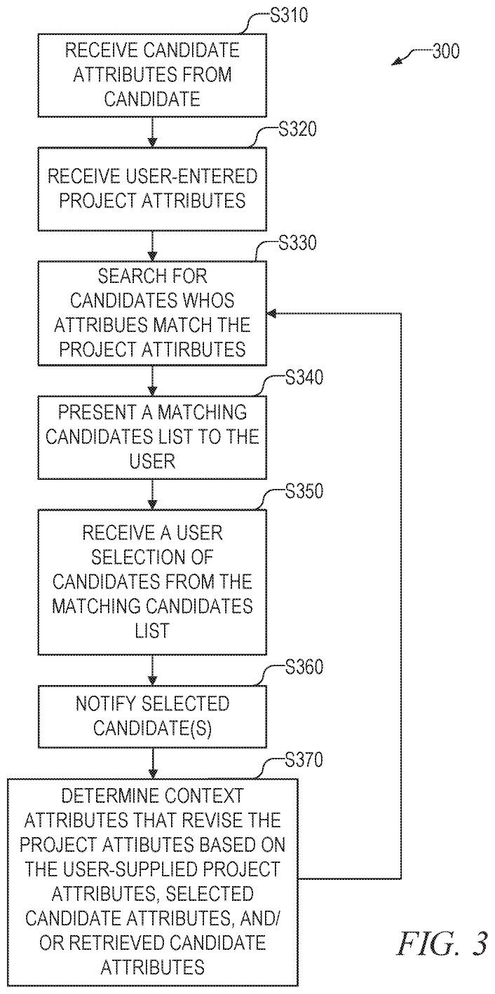

FIG. 3 is a flowchart that illustrates an example process 300 that may be utilized to operate the system 100 described above. In operation S310 the system 100 may receive candidate attributes 115 from a candidate 20 via a network-connected candidate device 25. Although operation S310 is shown as occurring at the start of the process, this operation may be ongoing throughout the life of the project, as candidates themselves may be signing on continuously, creating a changing candidate pool from which the users 10 may search.

In operation S320, the system may receive user-entered (project) attributes 152 that are desired to match with candidate attributes. As with operation S310, the user 10 may change the user-entered attributes 152 at any time during the project. These user-entered attributes 152 may be stored in a project record 145.1 in the project database 140.

In operation S330, a search is performed, as described above for candidates 20 whose candidate attributes 115 match with the project attributes 145, according to some formula and threshold that may weight the importance of the various attributes. The search may be triggered by a search trigger. The search trigger may be a user operation performed by the user 10 who initiates via the user device 15 by, for example, by interacting with a display on their device, by, e.g., clicking a button or selecting a displayed menu item or the like. The search trigger may be a system trigger that triggers the search. In one example, this system trigger may be a system operation that is an expiration of a timer so that the search is performed periodically, such as once per day. In another example, this system trigger may be the completion of an activity, such as the creation of a new project attribute 145 (either a user-entered attribute 152 or a generated context attribute 154) or by the input of a certain number of new candidates 20 or the like. The result of the search is a set of matched candidates 20 whose candidate attributes 115 match the project attributes 145 according to some formula.

In operation S340, the set of matched candidates 20 is presented to the user 10 in such a way as to be selectable by the user 10, such as by presenting the set in a list on the user's display screen with a selection element such as a checkbox or button next to each candidate 20 in the set.

In operation S350, the system 100 receives from the user 10 a set of selected candidates 20 that represents candidates of interest to the user. In operation S360, the system 100 may notify the candidates in the set of selected candidates of the user's 10 interest in further interaction with them. This notification may be in a form of an email, text message, or an in-application notification such as a pop-up window, message display area, and the like.

In operation S370, further project attributes 145 may be generated by the system, which are generated context attributes 154. An example of the bases for generating the context attributes 154 is described above with respect to FIG. 2. These context attributes 154 change the project attributes 145 so that when the search is performed again in operation S330, even on the exact same candidate pool, a new set of matched candidates 20 may be produced. The project record 145.1 may contain a list of the candidates 20 who have already been seen by the user 10 so that the user 10 is not presented with a candidate multiple times. The underlying candidate 20 pool is also constantly changing, so even if the project attributes 145 have not changed, a new set of matched candidates may still be produced based on candidates 20 newly added to the candidate pool. Operation S370 may then return to operation S330 to repeat the search of the candidate pool potentially having new candidates and the search utilizing potentially modified project attributes, thereby producing a new set of matched candidates and repeating the process. In one example, a configurable flag or other control may be used to indicate whether only new (unseen) candidates 20 are presented to the user 10 for a given search, or whether all candidates 20, including those already seen by the user 10.

The project attributes 145, both the user-entered attributes 152 and the generated context attributes 154, could have their weighting factors change as well in order to emphasize and deemphasize various attributes. As defined herein, use of the term of project attributes 145 may include these attributes or factors, along with their weighting.

The process may terminate at any time and according to any predefined criteria. However, once the project goals (e.g., a suitable candidate was selected, notified of desired further contact, and responded) have been achieved, the project may become dormant and no longer perform searches and updates on candidate sets.

### Software & System Architecture

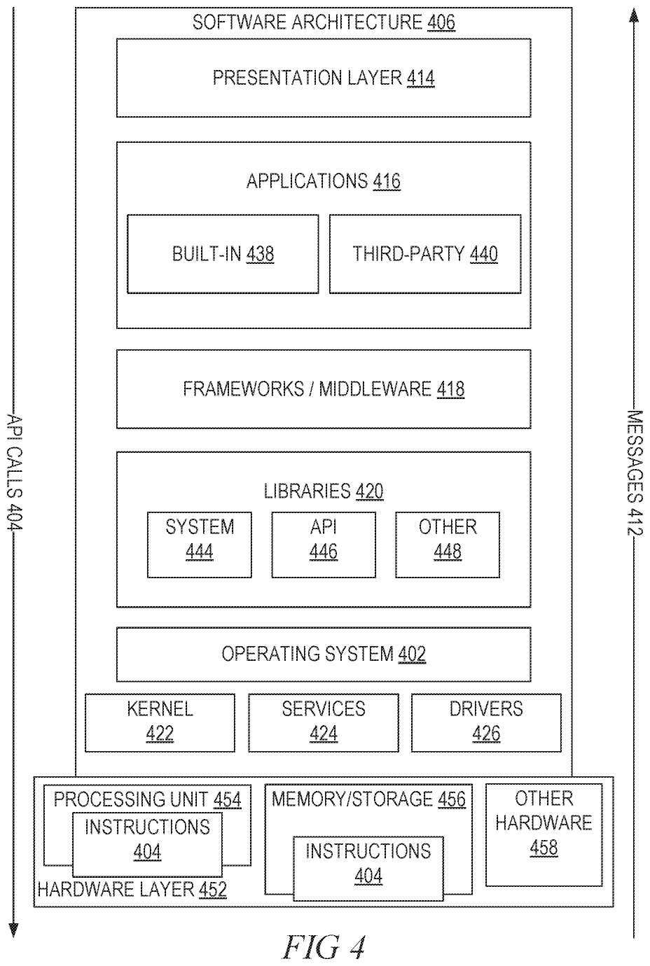

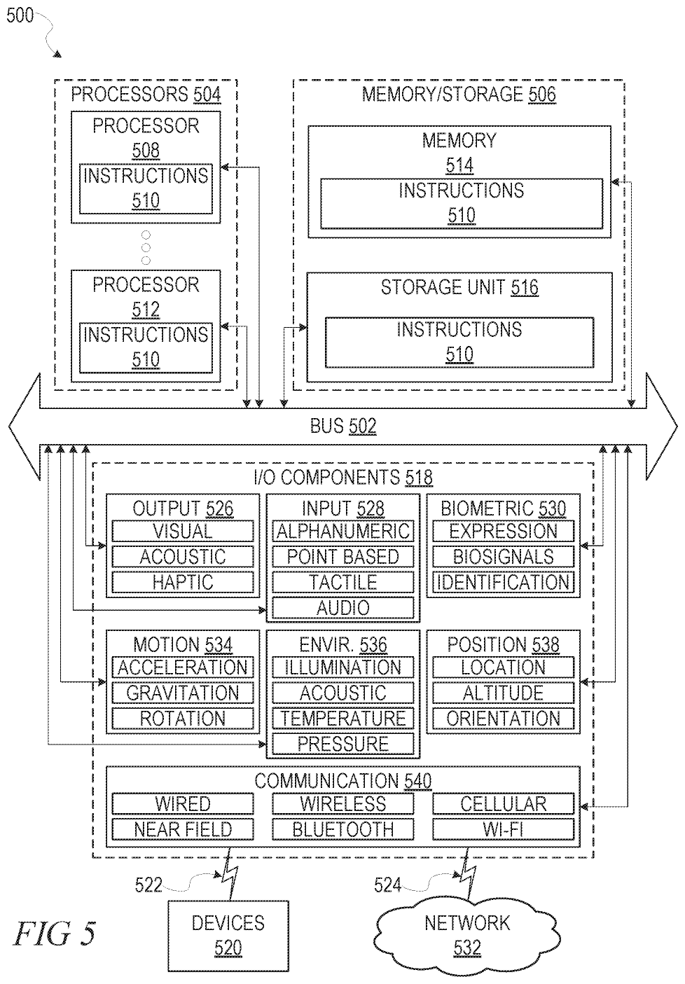

FIG. 4 is a block diagram illustrating an example software architecture 406, which may be used in conjunction with various hardware architectures herein described. FIG. 4 is a non-limiting example of a software architecture 406 and it will be appreciated that many other architectures may be implemented to facilitate the functionality described herein. The software architecture 406 may execute on hardware such as machine 500 of FIG. 5 that includes, among other things, processors 504, memory 514, and (input/output) I/O components 518. A representative hardware layer 452 is illustrated and can represent, for example, the machine 500 of FIG. 5. The representative hardware layer 452 includes a processing unit 454 having associated executable instructions 404. Executable instructions 404 represent the executable instructions of the software architecture 406, including implementation of the methods, components, and so forth described herein. The hardware layer 452 also includes memory and/or storage modules memory/storage 456, which also have executable instructions 404. The hardware layer 452 may also comprise other hardware 458.

In the example architecture of FIG. 4, the software architecture 406 may be conceptualized as a stack of layers where each layer provides particular functionality. For example, the software architecture 406 may include layers such as an operating system 402, libraries 420, frameworks/middleware 418, applications 416, and a presentation layer 414. Operationally, the applications 416 and/or other components within the layers may invoke API calls 408 through the software stack and receive a response such as messages 412 in response to the API calls 408. The layers illustrated are representative in nature and not all software architectures have all layers. For example, some mobile or special purpose operating systems may not provide a frameworks/middleware 418, while others may provide such a layer. Other software architectures may include additional or different layers.

The operating system 402 may manage hardware resources and provide common services. The operating system 402 may include, for example, a kernel 422. services 424, and drivers 426. The kernel 422 may act as an abstraction layer between the hardware and the other software layers. For example, the kernel 422 may be responsible for memory management, processor management (e.g., scheduling), component management, networking, security settings, and so on. The services 424 may provide other common services for the other software layers. The drivers 426 are responsible for controlling or interfacing with the underlying hardware. For instance, the drivers 426 include display drivers, camera drivers, Bluetooth® drivers, flash memory drivers, serial communication drivers (e.g., Universal Serial Bus (USB) drivers), Wi-Fi® drivers, audio drivers, power management drivers, and so forth, depending on the hardware configuration.

The libraries 420 provide a common infrastructure that is used by the applications 416 and/or other components and/or layers. The libraries 420 provide functionality that allows other software components to perform tasks in an easier fashion than to interface directly with the underlying operating system 402 functionality (e.g., kernel 422, services 424 and/or drivers 426). The libraries 420 may include system libraries 444 (e.g., C standard library) that may provide functions such as memory allocation functions, string manipulation functions, mathematical functions, and the like. In addition, the libraries 420 may include API libraries 446 such as media libraries (e.g., libraries to support presentation and manipulation of various media format such as MPEG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 420 may also include a wide variety of other libraries 448 to provide many other APIs to the applications 416 and other software components/modules.

The frameworks/middleware 418 (also sometimes referred to as middleware) provide a higher-level common infrastructure that may be used by the applications 416 and/or other software components/modules. For example, the frameworks/middleware 418 may provide various graphic user interface (GUI) functions, high-level resource management, high-level location services, and so forth, The frameworks/middleware 418 may provide a broad spectrum of other APIs that may be used by the applications 416 and/or other software components/modules, some of which may be specific to a particular operating system 402 or platform.

The applications 416 include built-in applications 438 and/or third-party applications 440. Examples of representative built-in applications 438 may include, but are not limited to, a contacts application, a browser application, a book reader application, a location application, a media application, a messaging application, and/or a game application. Third-party applications 440 may include an application developed using the ANDROID™ or IOS™ software development kit (SDK) by an entity other than the vendor of the particular platform, and may be mobile software running on a mobile operating system such as IOS™, ANDROID™, WINDOWS® Phone, or other mobile operating systems. The third-party applications 440 may invoke the API calls 408 provided by the mobile operating system (such as operating system 402) to facilitate functionality described herein.

The applications 416 may use built in operating system functions (e.g., kernel 422, services 424 and/or drivers 426), libraries 420, and frameworks/middleware 418 to create user interfaces to interact with users of the system. Alternatively, or additionally, in some systems, interactions with a user may occur through a presentation layer, such as presentation layer 414. In these systems, the application/component “logic” can be separated from the aspects of the application/component that interact with a user.

FIG. 5 is a block diagram illustrating components of a machine 500, according to some example embodiments, able to read instructions 504 from a machine-readable medium (e.g., a machine-readable storage medium) and perform any one or more of the methodologies discussed herein. Specifically, FIG. 5 shows a diagrammatic representation of the machine 500 in the example form of a computer system, within which instructions 510 (e.g., software, a program, an application, an applet, an app, or other executable code) for causing the machine 500 to perform any one or more of the methodologies discussed herein may be executed. As such, the instructions 510 may be used to implement modules or components described herein. The instructions 510 transform the general, non-programmed machine 500 into a particular machine 500 programmed to carry out the described and illustrated functions in the manner described. In alternative embodiments, the machine 500 operates as a standalone device or may be coupled (e.g., networked) to other machines. In a networked deployment, the machine 500 may operate in the capacity of a server machine or a client machine in a server-client network environment, or as a peer machine in a peer-to-peer (or distributed) network environment. The machine 500 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine 500 capable of executing the instructions 510, sequentially or otherwise, that specify actions to be taken by machine 500. Further, while only a single machine 500 is illustrated, the term “machine” shall also be taken to include a collection of machines that individually or jointly execute the instructions 510 to perform any one or more of the methodologies discussed herein.

The machine 500 may include processors 504, memory/storage 506, and I/O components 518, which may be configured to communicate with each other such as via a bus 502. The memory/storage 506 may include a memory 514, such as a main memory, or other memory storage, and a storage unit 516, both accessible to the processors 504 such as via the bus 502. The storage unit 516 and memory 514 store the instructions 510 embodying any one or more of the methodologies or functions described herein. The instructions 510 may also reside, completely or partially, within the memory 514, within the storage unit 516, within at least one of the processors 504 (e.g., within the processor's cache memory), or any suitable combination thereof, during execution thereof by the machine 500. Accordingly, the memory 514, the storage unit 516, and the memory of processors 504 are examples of machine-readable media.

The I/O components 518 may include a wide variety of components to receive input, provide output, produce output, transmit information, exchange information, capture measurements, and so on. The specific I/O components 518 that are included in a particular machine 500 will depend on the type of machine. For example, portable machines such as mobile phones will likely include a touch input device or other such input mechanisms, while a headless server machine will likely not include such a touch input device. It will be appreciated that the I/O components 518 may include many other components that are not shown in FIG. 5. The I/O components 518 are grouped according to functionality merely for simplifying the following discussion and the grouping is in no way limiting. In various example embodiments, the I/O components 518 may include output components 526 and input components 528. The output components 526 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 528 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 518 may include biometric components 530, motion components 534, environmental components 536, or position components 538 among a wide array of other components. For example, the biometric components 530 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 534 may include acceleration sensor components (e.g., accelerometer), gravitation sensor components, rotation sensor components (e.g., gyroscope), and so forth. The environmental components 536 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 538 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 518 may include communication components 540 operable to couple the machine 500 to a network 532 or devices 520 via. coupling 524 and coupling 522, respectively. For example, the communication components 540 may include a network interface component or other suitable device to interface with the network 532. In further examples, communication components 540 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 520 may be another machine or any of a wide variety of peripheral devices (e.g., a peripheral device coupled via a USB).

Moreover, the communication components 540 may detect identifiers or include components operable to detect identifiers. For example, the communication components 540 may include radio frequency identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 540, such as, location via Internet Protocol (IP) geo-location, location via Wi-Fi® signal triangulation, location via detecting a NFC beacon signal that may indicate a particular location, and so forth.

### Glossary

“CARRIER SIGNAL” in this context refers to any intangible medium that is capable of storing, encoding, or carrying instructions 510 for execution by the machine 500, and includes digital or analog communications signals or other intangible medium to facilitate communication of such instructions 510. Instructions 510 may be transmitted or received over the network 532 using a transmission medium via a network interface device and using any one of a number of well-known transfer protocols.

“CLIENT DEVICE” in this context refers to any machine 500 that interfaces to a communications network 532 to obtain resources from one or more server systems or other client devices. A client, user, or other device described herein may be, but is not limited to, a mobile phone, desktop computer, laptop, PDAs, smart phones, tablets, ultra books, netbooks, laptops, multi-processor systems, microprocessor-based or programmable consumer electronics, game consoles, STBs, or any other communication device that a user may use to access a network 532.

“COMMUNICATIONS NETWORK” in this context refers to one or more portions of a network 532 that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network 532 or a portion of a network 532 may include a wireless or cellular network and the coupling may be a Code Division Multiple Access (CDMA) connection, a Global System for Mobile communications (GSM) connection, or other type of cellular or wireless coupling. In this example, the coupling may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UNITS), High Speed Packet Access (HSPA), Worldwide Interoperability for Microwave Access (WiMAX), Long Term Evolution (LTE) standard, others defined by various standard setting organizations, other long range protocols, or other data transfer technology.

“MACHINE-READABLE MEDIUM” in this context refers to a component, device or other tangible media able to store instructions 510 and data temporarily or permanently and may include, but is not be limited to, random-access memory (RAM), read-only memory (ROM), buffer memory, flash memory, optical media, magnetic media, cache memory, other types of storage (e.g., erasable programmable read-only memory (EEPROM)), and/or any suitable combination thereof. The term “machine-readable medium” should be taken to include a single medium or multiple media (e.g., a centralized or distributed database, or associated caches and servers) able to store instructions 510. The term “machine-readable medium” shall also be taken to include any medium, or combination of multiple media, that is capable of storing instructions 510 (e.g., code) for execution by a machine 500, such that the instructions 510, when executed by one or more processors 504 of the machine 500, cause the machine 500 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

“COMPONENT” in this context refers to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors 504) may be configured by software (e.g., an application 816 or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application specific integrated circuit (ASIC). A hardware component may also include programmable logic or circuitry that is temporarily configured by software to perform certain operations. For example, a hardware component may include software executed by a general-purpose processor 504 or other programmable processor 504. Once configured by such software, hardware components become specific machines 500 (or specific components of a machine 500) uniquely tailored to perform the configured functions and are no longer general-purpose processors 504. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component”(or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where a hardware component comprises a general-purpose processor 504 configured by software to become a special-purpose processor, the general-purpose processor 504 may be configured as respectively different special-purpose processors (e.g., comprising different hardware components) at different times. Software accordingly configures a particular processor or processors 504, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses 502) between or among two or more of the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors 504 that are temporarily configured (e.g., by software) or permanently configured to perform the relevant operations. Whether temporarily or permanently configured, such processors 504 may constitute processor-implemented components that operate to perform one or more operations or functions described herein. As used herein, “processor-implemented component” refers to a hardware component implemented using one or more processors 504. Similarly, the methods described herein may be at least partially processor-implemented, with a particular processor or processors 504 being an example of hardware. For example, at least some of the operations of a method may be performed by one or more processors 504 or processor-implemented components. Moreover, the one or more processors 504 may also operate to support performance of the relevant operations in a “cloud computing” environment or as a “software as a service” (SaaS). For example, at least some of the operations may be performed by a group of computers (as examples of machines 500 including processors 504), with these operations being accessible via a network 532 (e.g., the Internet) and via one or more appropriate interfaces (e.g., an API). The performance of certain of the operations may be distributed among the processors 504, not only residing within a single machine 500, but deployed across a number of machines 500. In some example embodiments, the processors 504 or processor-implemented components may be located in a single geographic location (e.g., within a home environment, an office environment, or a server farm). In other example embodiments, the processors 504 or processor-implemented components may be distributed across a number of geographic locations.

“PROCESSOR” in this context refers to any circuit or virtual circuit (a physical circuit emulated by logic executing on an actual processor) that manipulates data values according to control signals (e.g., “commands,” “op codes,” “machine code,” etc.) and which produces corresponding output signals that are applied to operate a machine 500. A processor 504 may be, for example, a central processing unit (CPU), a reduced instruction set computing (RISC) processor, a complex instruction set computing (CISC) processor, a graphics processing unit (GPU), a digital signal processor (DSP), an ASIC, a radio-frequency integrated circuit (RFIC) or any combination thereof. A processor may further be a multi-core processor having two or more independent processors 504 (sometimes referred to as “cores”) that may execute instructions 510 contemporaneously.

### Network Architecture

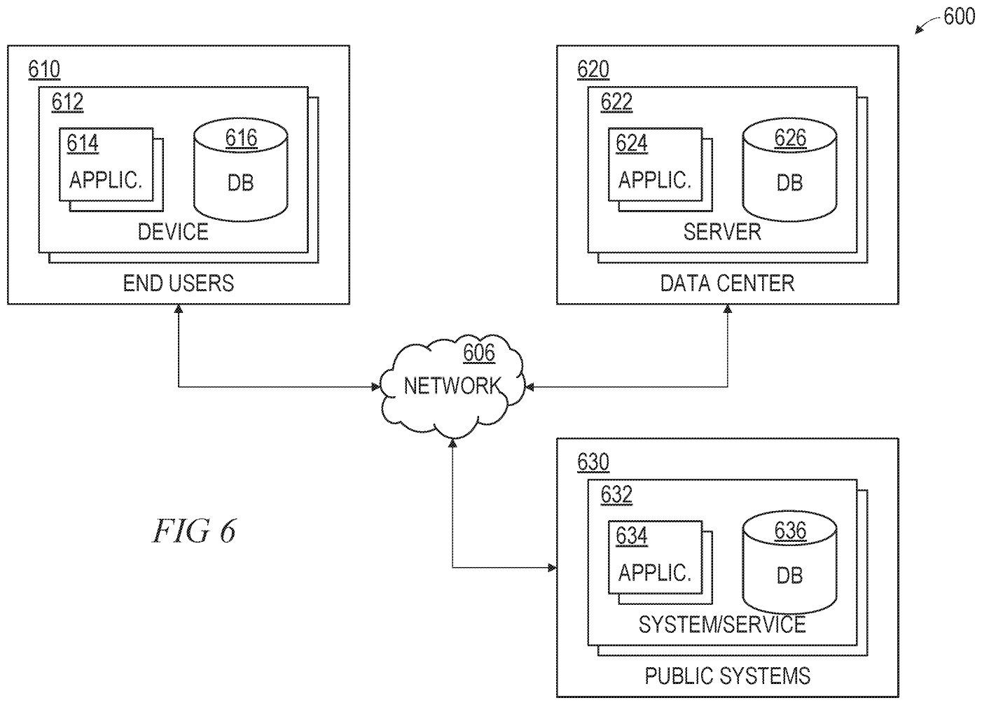

FIG. 6 is a block diagram of a distributed system 600 that may include a client-server architecture or cloud computing system. The system 600 may be a system 100 as described above. Distributed system 600 may have one or more end users 610. An end user 610 may have various computing devices 612, which may be machines 500 as described above. The end-user computing devices 612 may comprise applications 614 that are either designed to execute in a stand-alone manner, or interact with other applications 614 located on the device 612 or accessible via the network 505. These devices 612 may also comprise a data store 616 that holds data locally, the data being potentially accessible by the local applications 614 or by remote applications.

The system 600 may also include one or more data centers 620. A data center 620 may be a server 622 or the like associated with a business entity that an end user 610 may interact with. The business entity may be a computer service provider, as may be the case for a cloud services provider, or it may be a consumer product or service provider, such as a retailer. The data center 620 may comprise one or more applications 624 and databases 626 that are designed to interface with the applications 614 and databases 616 of end-user devices 612. Data centers 620 may represent facilities in different geographic locations where the servers 622 may be located. Each of the servers 622 may be in the form of a machine(s) 500.

The system 600 may also include publicly available systems 630 that comprise various systems or services 632, including applications 634 and their respective databases 636. Such applications 634 may include news and other information feeds, search engines, social media applications, and the like. The systems or services 632 may be provided as comprising a machine(s) 500.

The end-user devices 612, data center servers 622, and public systems or services 632 may be configured to connect with each other via the network 605, and access to the network by machines may be made via a common connection point or different connection points, e.g. a wireless connection point and a wired connection. Any combination of common or different connections points may be present, and any combination of wired and wireless connection points may be present as well. The network 605, end users 610, data centers 620, and public systems 630 may include network hardware such as routers, switches, load balancers and/or other network devices.

Other implementations of the system 600 are also possible. For example, devices other than the client devices 612 and servers 622 shown may be included in the system 600. In an implementation, one or more additional servers may operate as a cloud infrastructure control, from which servers and/or clients of the cloud infrastructure are monitored, controlled and/or configured. For example, some or all of the techniques described herein may operate on these cloud infrastructure control servers. Alternatively, or in addition, some or all of the techniques described herein may operate on the servers 622.

What is claimed is:

1. A method comprising, with a processor of a computer system:
receiving, via a network interface, candidate attributes from candidate devices of a plurality of candidates and storing them in a candidate database in a. memory of the computer system;
receiving, via the network interface, user-entered attributes from a user device of a user that are a first part of project attributes of a project and storing the project attributes in a project database in the memory;
iteratively executing:
performing a search for candidates in the candidate database by comparing project attributes with candidate attributes and producing search results;
providing a user notification of newly-matched candidates that includes returning returned candidates that are matching candidates of the search results to the user based on the search, the returned candidates being candidates that the user has not previously seen, and marking the returned candidates as previously seen;
receiving a selected candidate of the returned candidates selected by the user; and
generating context attributes that are a second part of the project attributes from a context attribute source, wherein the generated context attributes include at least one of the user-entered attributes, candidate attributes of the returned candidates, candidate attributes of the selected candidate, candidate attributes of historical candidates, or project attributes of an additional project.

2. The method of claim 1, wherein:
the search determines candidate match scores for candidates in the candidate database that utilizes an attribute weighting and degree of match between one or more project attributes and corresponding candidate attributes; and
the returned candidates are those candidates whose candidate match score exceed a pre-determined threshold.

3. The method of claim 1, wherein the iteratively executing further comprises sending a candidate notification to the selected candidate responsive to receiving the selected candidate.

4. The method of claim 3, wherein the candidate notification is a communication indicating an interest of the user to have further interaction with the selected candidate and is at least one of an email, a text message, and an in-application message.

5. The method of claim 1, wherein candidate attributes and project attributes are at least one of job title, previous jobs held, salary information, location information, demographic information, key descriptive words, prior employers, education, or interests.

6. The method of claim 1, wherein the iteratively executing further comprises receiving candidate attributes from a further candidate.

7. The method of claim 1, wherein the user notification is at least one of a display within a web browser, a user interface of a dedicated application, an email, a text message, or file.

8. The method of claim 1, wherein the generated context attributes are attributes present in a plurality of context attribute sources, but are not present in the user-entered attributes.

9. The method of claim 1, wherein:
the performing of the search is triggered by a search trigger that is at least one of a user operation performed by interacting with their device or a system operation that is an expiration of a timer or a completion of an activity; and
the providing of the user notification is triggered by a notification trigger that is a completion of the search.

10. A system comprising:
one or more computer processors
a memory; and
one or more computer-readable mediums storing instructions that, when executed by the one or more computer processors, cause the system to:
receive, via a network interface, candidate attributes from candidate devices of a plurality of candidates and store them in a candidate database in the memory;
receive, via the network interface, user-entered attributes from a user device of a user that are a first part of project attributes of a project and store the project attributes in a project database in the memory;
iteratively execute, causing the system
perform a search for candidates in the candidate database by comparing project attributes with candidate attributes and produce search results;
provide user notification of newly-matched candidates that includes returning returned candidates that are matching candidates of the search results to the user based on the search, the returned candidates being candidates that the user has not previously seen, and marking the returned candidates as previously seen;
receive a selected candidate of the returned candidates selected by the user; and
generate context attributes that are a second part of the project attributes from a context attribute source, wherein the generated context attributes include at least one of the user-entered attributes, candidate attributes of the returned candidates, candidate attributes of the selected candidate, candidate attributes of historical candidates, or project attributes of an additional project.

11. The system of claim 10, wherein:
the search determines candidate match scores for candidates in the candidate database that utilizes an attribute weighting and degree of match between one or more project attributes and corresponding candidate attributes; and
the returned candidates are those candidates whose candidate match score exceed a pre-determined threshold.

12. The system of claim 10, wherein the one or more processors is further configured to, in the iteratively execution, send a candidate notification to the selected candidate responsive to receipt of the selected candidate.

13. The system of claim 12, wherein the candidate notification is a communication indicating an interest of the user to have further interaction with the selected candidate and is at least one of an email, a text message, and an in-application message.

14. The system of claim 10, wherein candidate attributes and project attributes are at least one of job title, previous jobs held, salary information, location information, demographic information, key descriptive words, prior employers, education, or interests.

15. The system of claim 10, wherein the one or more processors is further configured to, in the iteratively execution, receive candidate attributes from a. further candidate.

16. The system of claim 10, wherein the user notification is at least one of a display within a web browser, a user interface of a dedicated application, an email, a text message, or file.

17. The system of claim 10, wherein the generated context attributes are attributes present in a plurality of context attribute sources, but are not present in the user-entered attributes.

18. The system of claim 10, wherein:
the performance of the search is triggered by a search trigger that is at least one of a user operation performed by interacting with their device or a system operation that is an expiration of a timer or a completion of an activity; and
the provision of the user notification is triggered by a notification trigger that is a completion of the search.

19. A non-transitory computer-readable medium storing instructions that, when executed by one or more computer processors of a computing device, cause the computing device to perform operations comprising:
receiving, via a network interface, candidate attributes from candidate devices of a plurality of candidates and storing them in a candidate database in a. memory of the computing device;
receiving, via the network interface, user-entered attributes from a user device of a user that are a first part of project attributes of a project and storing the project attributes in a project database in the memory;
iteratively executing:
performing a search for candidates in the candidate database by^{,} comparing project attributes with candidate attributes and producing search results;
providing user notification of newly-matched candidates that includes returning returned candidates that are matching candidates of the search results to the user based on the search, the returned candidates being candidates that the user has not previously seen, and marking the returned candidates as previously seen;
receiving a selected candidate of the returned candidates selected by the user; and
generating context attributes that are a second part of the project attributes from a context attribute source, wherein the generated context attributes include at least one of the user-entered attributes, candidate attributes of the returned candidates, candidate attributes of the selected candidate, candidate attributes of historical candidates, or project attributes of an additional project.

20. The non-transitory computer-readable medium of claim 19, wherein:
the search determines candidate match scores for candidates in the candidate database that utilizes an attribute weighting and degree of match between one or more project attributes and corresponding candidate attributes; and
the returned candidates are those candidates whose candidate match score exceed a pre-determined threshold.
